(19) United States
(12) Patent Application Publication
(10) Pub. No.: US 2024/0407343 A1
(43) Pub. Date: Dec. 12, 2024

(54) BEHAVIOR MODIFICATION DEVICE, BEHAVIOR MODIFICATION METHOD, AND BEHAVIOR MODIFICATION SYSTEM

(71) Applicant: Mitsubishi Electric Corporation, Tokyo (JP)

(72) Inventors: Koji IBATA, Tokyo (JP); Jin HIRANO, Tokyo (JP); Tomoharu AWANO, Tokyo (JP); Misato WATANABE, Tokyo (JP)

(73) Assignee: Mitsubishi Electric Corporation, Tokyo (JP)

(21) Appl. No.: 18/808,776

(22) Filed: Aug. 19, 2024

Related U.S. Application Data
(63) Continuation of application No. PCT/JP2022/018996, filed on Apr. 27, 2022.

(51) Int. Cl. A01K 61/95; A01K 29/00; A01K 79/02; A01M 29/16

(52) U.S. Cl. CPC A01K 61/95; A01K 29/005; A01K 79/02; A01M 29/16; A01K 2227/40

(57) ABSTRACT

A behavior modification device includes processing circuitry configured to: acquire sensing information of a sensor to observe a monitoring area; identify behavior of an organism to be threatened present in the monitoring area on a basis of the acquired sensing information; determine a parameter of a stimulus to be given to the organism on a basis of the identified behavior; and generate stimulus data for generating the stimulus on a basis of the determined parameter and output the stimulus data to an actuator for generating a stimulus.

### CROSS REFERENCE TO RELATED APPLICATIONS

This application is a Continuation of PCT International Application No. PCT/JP2022/018996, filed on Apr. 27, 2022, which is hereby expressly incorporated by reference into the present application.

### TECHNICAL FIELD

The present disclosure relates to a behavior modification device, a behavior modification method, and a behavior modification system.

### BACKGROUND ART

In a culture farm for growing a cultured product such as fish or shellfish, a farm for growing an agricultural product such as a vegetable, or the like, for example, a feeding damage that a cultured product or the like is eaten by a wild organism may occur. As a general measure for preventing occurrence of the feeding damage, there is a measure of surrounding an area where a cultured product or the like is present (hereinafter, referred to as “protective area”) with a net. However, for example, a situation in which the net is swept away by a tidal current or a situation in which a wild organism enters the protective area through a gap of a net may occur. For this reason, in the measure of surrounding the protective area with a net, occurrence of the feeding damage cannot be suppressed in some cases.

As a system that suppresses occurrence of the feeding damage without using a net, there is a repellent system that repels an organism that causes the feeding damage (hereinafter, referred to as “vermin”) by giving a stimulus to the vermin (See, for example, Patent Literature 1).

The repellent system includes a stimulus selecting device and a stimulus generating device. The stimulus selecting device includes an identifying unit that identifies the kind of vermin, a stimulus data storing unit storing stimulus data for generating a stimulus to be given to the vermin for each kind of the vermin, and a selecting unit that selects stimulus data corresponding to the kind identified by the identifying unit from among a plurality of pieces of stimulus data stored in the stimulus data storing unit. The stimulus generating device generates a stimulus on the basis of the stimulus data selected by the stimulus selecting device, and gives the generated stimulus to the vermin.

### CITATION LIST

### Patent Literature

Patent Literature 1: JP 2021-90355 A

### SUMMARY OF INVENTION

### Technical Problem

The repellent system disclosed in Patent Literature 1 has a problem that when there is no stimulus data corresponding to the kind of vermin among a plurality of pieces of stimulus data stored in the stimulus data storing unit, vermin cannot be repelled.

The present disclosure has been made in order to solve the problem as described above, and an object of the present disclosure is to provide a behavior modification device capable of repelling vermin that is an organism to be threatened without storing stimulus data corresponding to the kind of the vermin.

### Solution to Problem

A behavior modification device according to the present disclosure includes: processing circuitry configured to acquire sensing information of a sensor that observes a monitoring area; identify behavior of an organism to be threatened present in the monitoring area on the basis of the acquired sensing information; determine a parameter of a stimulus to be given to an organism on the basis of the identified behavior; generate stimulus data for generating the stimulus on the basis of the determined parameter; and output the stimulus data to an actuator for generating the stimulus, wherein the stimulus is a sound wave, and the parameter of the stimulus is at least one of a frequency change amount and a sound interval change amount, and wherein when the identified behavior of the organism corresponds to behavior of approaching a protective area in the monitoring area or behavior of stopping, the processing circuitry determines the parameter of the stimulus in such a manner as to increase the at least one of the frequency change amount and the sound interval change amount, and when the identified behavior of the organism corresponds to behavior of moving away from the protective area, the processing circuitry determines the parameter of the stimulus in such a manner as to decrease the at least one of the frequency change amount and the sound interval change amount.

### Advantageous Effects of Invention

According to the present disclosure, it is possible to repel vermin that is an organism to be threatened without storing stimulus data corresponding to the kind of the vermin.

### BRIEF DESCRIPTION OF DRAWINGS

FIG. 1 is a configuration diagram illustrating a behavior modification system including a behavior modification device 2 according to a first embodiment.

FIG. 2 is a hardware configuration diagram illustrating hardware of the behavior modification device 2 according to the first embodiment.

FIG. 3 is a hardware configuration diagram of a computer in a case where the behavior modification device 2 is implemented by software, firmware, or the like.

FIG. 4 is a flowchart illustrating a behavior modification method that is a processing procedure performed in the behavior modification device 2.

FIG. 5 is a configuration diagram illustrating a behavior modification system including a behavior modification device 2 according to a second embodiment.

FIG. 6 is a hardware configuration diagram illustrating hardware of the behavior modification device 2 according to the second embodiment.

FIG. 7 is a configuration diagram illustrating a behavior modification system including a behavior modification device 2 according to a third embodiment.

FIG. 8 is a hardware configuration diagram illustrating hardware of the behavior modification device 2 according to the third embodiment.

### DESCRIPTION OF EMBODIMENTS

Hereinafter, in order to describe the present disclosure in more detail, embodiments for carrying out the present disclosure will be described with reference to the attached drawings.

### First Embodiment

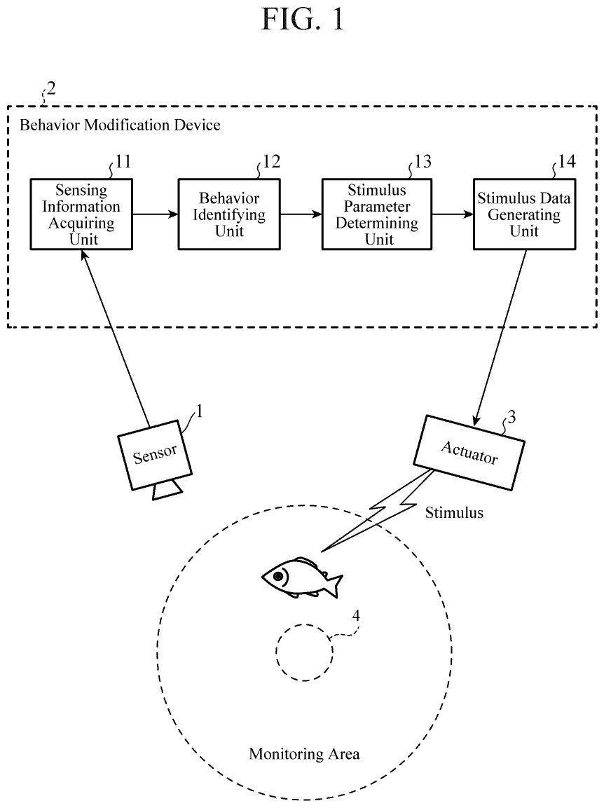

FIG. 1 is a configuration diagram illustrating a behavior modification system including a behavior modification device 2 according to a first embodiment.

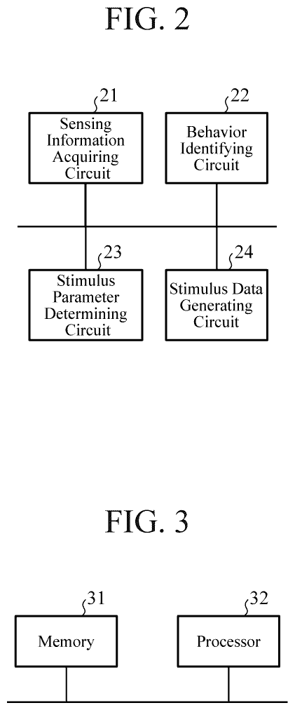

FIG. 2 is a hardware configuration diagram illustrating hardware of the behavior modification device 2 according to the first embodiment.

In FIG. 1, a sensor 1 observes a monitoring area and detects an organism to be threatened (hereinafter, referred to as “threatening target organism”) present in the monitoring area.

The sensor 1 outputs, for example, sensing information indicating presence or absence of the threatening target organism to the behavior modification device 2 as an observation result of the monitoring area. The threatening target organism includes any organism that can cause a feeding damage. Therefore, the threatening target organism includes a wild animal living on the land in addition to wild fish living in the sea or a river.

The sensor 1 only needs to be a sensing device capable of detecting the threatening target organism present in the monitoring area, and the sensor 1 includes, for example, a microphone, an ultrasonic sensor, a camera, a laser speedometer, or a satellite receiver.

The sensor 1 may be disposed at any position as long as the sensor 1 can detect the threatening target organism present in the monitoring area. Therefore, the sensor 1 may be disposed inside the monitoring area or outside the monitoring area.

In the behavior modification system illustrated in FIG. 1, the sensor 1 is disposed outside the behavior modification device 2. However, this is merely an example, and the sensor 1 may be disposed inside the behavior modification device 2.

The behavior modification device 2 includes a sensing information acquiring unit 11, a behavior identifying unit 12, a stimulus parameter determining unit 13, and a stimulus data generating unit 14.

The behavior modification device 2 acquires sensing information output from the sensor 1, generates stimulus data for generating a stimulus to be given to the threatening target organism on the basis of the sensing information, and outputs the stimulus data to an actuator 3 for generating the stimulus.

The actuator 3 for generating the stimulus is implemented by, for example, a speaker, a light generating device, a smell generating device, or a vibration generating device.

The actuator 3 generates a stimulus to be given to the threatening target organism on the basis of the stimulus data output from the behavior modification device 2.

The actuator 3 generates, for example, a sound wave stimulus, a light stimulus, a smell stimulus, or a radio wave stimulus as the stimulus to be given to the threatening target organism.

In the behavior modification system illustrated in FIG. 1, the actuator 3 is disposed outside the behavior modification device 2. However, this is merely an example, and the actuator 3 may be disposed inside the behavior modification device 2.

A protective area 4 is an area present in the monitoring area. In the protective area 4, for example, there is a cultured product that may be eaten by the threatening target organism or an agricultural product that may be eaten by the threatening target organism.

When an object to be protected present in the protective area 4 is an organism such as a cultured product, a periphery of the protective area 4 is generally surrounded by a net for the purpose of preventing the organism to be protected from going outside the protective area 4.

The sensing information acquiring unit 11 is implemented by, for example, a sensing information acquiring circuit 21 illustrated in FIG. 2.

The sensing information acquiring unit 11 acquires sensing information of the sensor 1 and outputs the sensing information to the behavior identifying unit 12.

The behavior identifying unit 12 is implemented by, for example, a behavior identifying circuit 22 illustrated in FIG. 2.

The behavior identifying unit 12 acquires sensing information from the sensing information acquiring unit 11.

The behavior identifying unit 12 identifies behavior of the threatening target organism present in the monitoring area on the basis of the sensing information.

Specifically, the behavior identifying unit 12 determines whether behavior of the threatening target organism is behavior of approaching the protective area 4 in the monitoring area, behavior of moving away from the protective area 4, or the like.

The behavior identifying unit 12 outputs a behavior identifying result to the stimulus parameter determining unit 13.

The stimulus parameter determining unit 13 is implemented by, for example, a stimulus parameter determining circuit 23 illustrated in FIG. 2.

The stimulus parameter determining unit 13 determines a parameter of a stimulus to be given to the threatening target organism on the basis of the behavior identified by the behavior identifying unit 12.

Specifically, when the behavior identified by the behavior identifying unit 12 is behavior of approaching the protective area 4 in the monitoring area, the stimulus parameter determining unit 13 adjusts the parameter of the stimulus in such a manner that the larger a distance change amount approaching the protective area 4, the larger the stimulus.

In addition, when the behavior identified by the behavior identifying unit 12 is behavior of moving away from the protective area 4, the stimulus parameter determining unit 13 adjusts the parameter of the stimulus in such a manner that the larger a distance change amount moving away from the protective area 4, the smaller the stimulus.

As an initial value of the parameter of the stimulus, for example, a parameter effective for moving a threatening target organism assumed to have the highest possibility of approaching the protective area 4 away from the protective area 4 is used.

The stimulus parameter determining unit 13 outputs the parameter of the stimulus to the stimulus data generating unit 14.

The stimulus data generating unit 14 is implemented by, for example, a stimulus data generating circuit 24 illustrated in FIG. 2.

The stimulus data generating unit 14 acquires the parameter of the stimulus from the stimulus parameter determining unit 13.

The stimulus data generating unit 14 generates stimulus data on the basis of the parameter of the stimulus. The stimulus data generating unit 14 generates stimulus data for generating, for example, a sound wave stimulus, a light stimulus, a smell stimulus, or a radio wave stimulus as a stimulus to be given to the threatening target organism.

The stimulus data generating unit 14 outputs the stimulus data to the actuator 3.

In FIG. 1, it is assumed that each of the sensing information acquiring unit 11, the behavior identifying unit 12, the stimulus parameter determining unit 13, and the stimulus data generating unit 14, which are constituent elements of the behavior modification device 2, is implemented by dedicated hardware as illustrated in FIG. 2. That is, it is assumed that the behavior modification device 2 is implemented by the sensing information acquiring circuit 21, the behavior identifying circuit 22, the stimulus parameter determining circuit 23, and the stimulus data generating circuit 24.

To each of the sensing information acquiring circuit 21, the behavior identifying circuit 22, the stimulus parameter determining circuit 23, and the stimulus data generating circuit 24, for example, a single circuit, a composite circuit, a programmed processor, a parallel-programmed processor, an application specific integrated circuit (ASIC), a field-programmable gate array (FPGA), or a combination thereof corresponds.

The constituent elements of the behavior modification device 2 are not limited to those implemented by dedicated hardware, and the behavior modification device 2 may be implemented by software, firmware, or a combination of software and firmware.

Software or firmware is stored as a program in a memory of a computer. The computer means hardware that executes a program. To the computer, for example, a central processing unit (CPU), a central processing device, a processing device, an arithmetic device, a microprocessor, a microcomputer, a processor, or a digital signal processor (DSP) corresponds.

FIG. 3 is a hardware configuration diagram of a computer in a case where the behavior modification device 2 is implemented by software, firmware, or the like.

When the behavior modification device 2 is implemented by software, firmware, or the like, a program for causing a computer to execute a processing procedure in each of the sensing information acquiring unit 11, the behavior identifying unit 12, the stimulus parameter determining unit 13, and the stimulus data generating unit 14 is stored in a memory 31. A processor 32 of the computer executes the program stored in the memory 31.

FIG. 2 illustrates an example in which each of the constituent elements of the behavior modification device 2 is implemented by dedicated hardware, and FIG. 3 illustrates an example in which the behavior modification device 2 is implemented by software, firmware, or the like. However, this is merely an example, and some of the constituent elements of the behavior modification device 2 may be implemented by dedicated hardware, and the remaining constituent elements may be implemented by software, firmware, or the like.

Next, an operation of the behavior modification device 2 illustrated in FIG. 1 will be described.

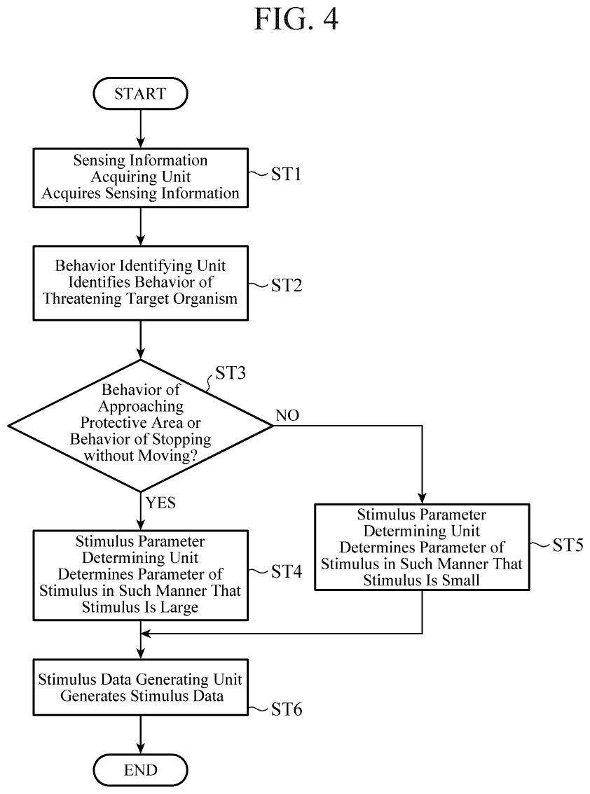

FIG. 4 is a flowchart illustrating a behavior modification method that is a processing procedure performed in the behavior modification device 2.

The sensor 1 observes the monitoring area and detects a threatening target organism present in the monitoring area.

When the threatening target organism is present in the monitoring area, the sensor 1 outputs sensing information including, for example, time information indicating a time t at which the threatening target organism is detected and position information indicating a presence position P of the threatening target organism to the behavior modification device 2 as an observation result of the monitoring area. The position information is, for example, coordinate information of the presence position P expressed in a three-dimensional coordinate system of the monitoring area.

For example, in a case where the sensor 1 includes a microphone, by analyzing a feature amount of a sound collected by the microphone, the sensor 1 determines whether or not the collected sound includes a sound related to the threatening target organism, different from an environmental sound. Then, the sensor 1 determines that the threatening target organism is present in the monitoring area when the sound related to the threatening target organism is included. Examples of a method for analyzing a feature amount of a sound include a sound frequency analyzing method and a sound cepstrum analyzing method.

Examples of the environmental sound include a sound of water generated by a tidal current. Examples of the sound related to the threatening target organism include a sound generated by swimming or a sound emitted from a mouth.

When the threatening target organism is present in the monitoring area, the sensor 1 can detect the presence position of the threatening target organism by identifying the position of a source of the collected sound. The position of the source of the sound can be estimated, for example, by executing a multiple signal classification (MUSIC) method.

Here, an example is illustrated in which the sensor 1 includes a microphone. However, this is merely an example, and for example, the sensor 1 may include a camera. In a case where the sensor 1 includes a camera, the sensor 1 can detect the threatening target organism present in the monitoring area by analyzing an image captured by the camera.

The sensing information acquiring unit 11 of the behavior modification device 2 acquires sensing information from the sensor 1 (step ST1 in FIG. 4).

The sensing information acquiring unit 11 outputs the sensing information to the behavior identifying unit 12.

The behavior identifying unit 12 acquires the sensing information from the sensing information acquiring unit 11.

The behavior identifying unit 12 extracts time information and position information from the sensing information, and identifies a presence position P (t) of the threatening target organism at a time t.

For example, when the presence position at a time t₁ is P (t₁) and the presence position at a time t₂ is P (t₂), the behavior identifying unit 12 calculates a distance R₁₋₀ between the presence position P (t₁) at the time t₁ and a center position P₀ of the protective area 4 in the monitoring area as expressed in the following equation (1). The center position P₀ of the protective area 4 may be stored in an internal memory of the behavior identifying unit 12 or may be given from the outside of the behavior modification device 2.

$$\\ \begin{matrix}{R}_{1 - 0} = \sqrt{{( {x}_{1} - {x}_{0} )}^{2} + {( {y}_{1} - {y}_{0} )}^{2} + {( {z}_{1} - {z}_{0} )}^{2}} & ( 1 )\end{matrix}$$

In equation (1), x₁ represents the position of an x coordinate at the presence position P (t₁) at the time t₁, y₁ represents the position of a y coordinate at the presence position P (t₁) at the time t₁, and z₁ represents the position of a z coordinate at the presence position P (t₁) at the time t₁.

x₀ represents the position of an x coordinate at the center position P₀ of the protective area 4, y₀ represents the position of a y coordinate at the center position P₀ of the protective area 4, and z₀ represents the position of a z coordinate at the center position P₀ of the protective area 4.

Here, an example is illustrated in which (x₀, y₀, z₀) indicates coordinates of the center position P₀ of the protective area 4. However, this is merely an example, and (x₀, y₀, z₀) may indicate, for example, coordinates of a position on an outer periphery of the protective area 4.

In addition, the behavior identifying unit 12 calculates a distance R₂₋₀ between the presence position P (t₂) at the time t₂ and the center position P₀ of the protective area 4 as expressed in the following equation (2).

$$\\ \begin{matrix}{R}_{2 - 0} = \sqrt{{( {x}_{2} - {x}_{0} )}^{2} + {( {y}_{2} - {y}_{0} )}^{2} + {( {z}_{2} - {z}_{0} )}^{2}} & ( 2 )\end{matrix}$$

In equation (2), x₂ represents the position of an x coordinate at the presence position P (t₂) at the time t₂, y₂ represents the position of a y coordinate at the presence position P (t₂) at the time t₂, and z₂ represents the position of a z coordinate at the presence position P (t₂) at the time t₂.

The behavior identifying unit 12 calculates a distance change amount ΔM by subtracting the distance R₁₋₀ from the distance R₂₋₀ as expressed in the following equation (3).

$$\\ \begin{matrix}Δ M = {R}_{2 - 0} - {R}_{1 - 0} & ( 3 )\end{matrix}$$

The behavior identifying unit 12 identifies behavior of the threatening target organism on the basis of the distance change amount ΔM (step ST2 in FIG. 4).

Specifically, when the distance change amount ΔM is a negative value, the behavior identifying unit 12 determines that the behavior of the threatening target organism is “behavior of approaching the protective area 4”.

When the distance change amount ΔM is 0, the behavior identifying unit 12 determines that the behavior of the threatening target organism is “behavior of stopping without moving”.

When the distance change amount ΔM is a positive value, the behavior identifying unit 12 determines that the behavior of the threatening target organism is “behavior of moving away from the protective area 4”.

The behavior identifying unit 12 outputs a behavior identifying result to the stimulus parameter determining unit 13.

The stimulus parameter determining unit 13 acquires a behavior identifying result from the behavior identifying unit 12.

If the behavior of the threatening target organism is “behavior of approaching the protective area 4” or “behavior of stopping without moving” (step ST3 in FIG. 4: YES), the stimulus parameter determining unit 13 determines a parameter of a stimulus in such a manner that a stimulus to be given to the threatening target organism is large (step ST4 in FIG. 4).

If the behavior of the threatening target organism is “behavior of moving away from the protective area 4” (step ST3 in FIG. 4: NO), the stimulus parameter determining unit 13 determines a parameter of a stimulus in such a manner that a stimulus to be given to the threatening target organism is small (step ST5 in FIG. 4).

Hereinafter, a process of determining a parameter by the stimulus parameter determining unit 13 will be specifically described.

For example, in a case where a sound is output from the actuator 3 as a stimulus to be given to the threatening target organism, the stimulus parameter determining unit 13 determines a sound frequency f change amount Δf and a sound interval T change amount ΔT as parameters of the stimulus.

That is, the stimulus parameter determining unit 13 determines the frequency f change amount Δf and the sound interval T change amount ΔT using the distance change amount ΔM as expressed in the following equations (4) to (7).

$$\\ \begin{matrix}Δ f = ( 1 - λ ) Δ f + λ Δ {f}^{{}_{} ′} & ( 4 )\end{matrix}$$

$$\\ \begin{matrix}Δ T = ( 1 - λ ) Δ T + λ Δ {T}^{{}_{} ′} & ( 5 )\end{matrix}$$

$$\\ \begin{matrix}Δ {f}^{{}_{} ′} = \frac{{γ}_{f}}{Δ M \cdot {α}_{f} + {β}_{f}} & ( 6 )\end{matrix}$$

$$\\ \begin{matrix}Δ {T}^{{}_{} ′} = \frac{{γ}_{T}}{Δ M \cdot {α}_{T} + {β}_{T}} & ( 7 )\end{matrix}$$

In equations (4) to (7), each of α_{f}, β_{f}, and γ_{f} represents a positive real number parameter set in order to calculate the frequency f change amount Δf.

Each of α_{T}, β_{T}, and γ_{T} represents a positive real number parameter set in order to calculate the sound interval T change amount ΔT.

Δf represents a temporarily calculated value of the frequency f change amount Δf, and ΔT′ represents a temporarily calculated value of the sound interval T change amount ΔT. λ represents a moving average parameter and is a real number value of 0 to 1.

Equation (4) is used for smoothing the frequency f change amount Δf. When it is not necessary to smooth the change amount Δf, the left side of equation (6) may be set to Δf, and the stimulus parameter determining unit 13 may calculate the frequency f change amount Δf by equation (6).

Equation (5) is used for smoothing the sound interval T change amount ΔT. When it is not necessary to smooth the change amount ΔT, the left side of equation (7) may be set to ΔT, and the stimulus parameter determining unit 13 may calculate the sound interval T change amount ΔT by equation (7).

As is clear from equation (6) and equation (7), when the behavior of the threatening target organism is “behavior of approaching the protective area 4” and the distance change amount ΔM is a negative value, each of the frequency f change amount Δf and the sound interval T change amount ΔT increases.

Each of the frequency f change amount Δf and the sound interval T change amount ΔT increases, whereby the stimulus to be given to the threatening target organism increases. As a result, it is expected that the behavior of the threatening target organism is modified to behavior of moving away from the protective area 4.

In addition, when the behavior of the threatening target organism is “behavior of moving away from the protective area 4” and the distance change amount ΔM is a positive value, each of the frequency f change amount Δf and the sound interval T change amount ΔT decreases.

Each of the frequency f change amount Δf and the sound interval T change amount ΔT decreases, whereby the stimulus to be given to the threatening target organism decreases. As a result, it is expected that the behavior of moving away from the protective area 4 is maintained as the behavior of the threatening target organism.

The stimulus data generating unit 14 acquires the parameter of the stimulus from the stimulus parameter determining unit 13.

The stimulus data generating unit 14 generates stimulus data on the basis of the parameter of the stimulus (step ST6 in FIG. 4). Since a process itself of generating the stimulus data on the basis of the parameter of the stimulus is a known technique, detailed description thereof is omitted.

The stimulus data generating unit 14 outputs the stimulus data to the actuator 3.

The actuator 3 acquires the stimulus data from the stimulus data generating unit 14 of the behavior modification device 2.

The actuator 3 generates a stimulus to be given to the threatening target organism on the basis of the stimulus data.

The actuator 3 generates, for example, a sound wave stimulus, a light stimulus, a smell stimulus, or a radio wave stimulus as the stimulus to be given to the threatening target organism.

The behavior modification device 2 illustrated in FIG. 1 repeatedly executes the processes of steps ST1 to ST6 until the behavior of the threatening target organism present in the monitoring area becomes the “behavior of moving away from the protective area 4” and the threatening target organism goes out of the monitoring area.

In the above first embodiment, the behavior modification device 2 is configured to include: the sensing information acquiring unit 11 that acquires sensing information of the sensor 1 that observes a monitoring area; and the behavior identifying unit 12 that identifies behavior of an organism to be threatened present in the monitoring area on the basis of the sensing information acquired by the sensing information acquiring unit 11. The behavior modification device 2 further includes: the stimulus parameter determining unit 13 that determines a parameter of a stimulus to be given to an organism on the basis of the behavior identified by the behavior identifying unit 12; and the stimulus data generating unit 14 that generates stimulus data for generating the stimulus on the basis of the parameter determined by the stimulus parameter determining unit 13, and outputs the stimulus data to the actuator 3 for generating the stimulus. Therefore, the behavior modification device 2 can repel vermin that is an organism to be threatened without storing stimulus data corresponding to the kind of the vermin.

In the behavior modification device 2 illustrated in FIG. 1, the behavior identifying unit 12 determines whether the behavior of the threatening target organism is “behavior of approaching the protective area 4”, “behavior of stopping without moving”, or “behavior of moving away from the protective area 4”. However, this is merely an example, and the behavior identifying unit 12 may determine that, for example, the behavior of the threatening target organism is behavior of moving in parallel with the protective area 4 without changing a distance from the protective area 4.

In the behavior modification device 2 illustrated in FIG. 1, the behavior identifying unit 12 calculates the distance change amount ΔM by subtracting the distance R₁₋₀ at the time t₁ from the distance R₂₋₀ at the time t₂. However, the time interval between the two distances is not limited to the interval between the time t₁ and the time t₂. Therefore, for example, the behavior identifying unit 12 may calculate the distance change amount ΔM by subtracting the distance R₁₋₀ at the time t₁ from a distance R₃₋₀ at a time t₃, or may calculate the distance change amount ΔM by subtracting the distance R₂₋₀ at the time t₂ from a distance R₅₋₀ at a time t₅.

In the behavior modification device 2 illustrated in FIG. 1, the stimulus parameter determining unit 13 determines the frequency f change amount Δf and the sound interval T change amount ΔT as the parameters of the stimulus using the distance change amount ΔM. However, this is merely an example. In a case where the behavior of the threatening target organism is “behavior of approaching the protective area 4”, when an absolute value of the distance change amount ΔM is equal to or less than a first threshold Th₁, the stimulus parameter determining unit 13 may maintain the parameters of the stimulus, and when the absolute value of the distance change amount ΔM is larger than the first threshold Th₁, the stimulus parameter determining unit 13 may determine the frequency f change amount Δf and the sound interval T change amount ΔT using the distance change amount ΔM. When the absolute value of the distance change amount ΔM is larger than the first threshold Th₁, the parameters of the stimulus are adjusted in such a manner that the larger the distance change amount ΔM, the larger the stimulus.

In a case where the behavior of the threatening target organism is “behavior of moving away from the protective area 4”, when an absolute value of the distance change amount ΔM is equal to or less than a second threshold Th₂, the stimulus parameter determining unit 13 may maintain the parameters of the stimulus, and when the absolute value of the distance change amount ΔM is larger than the second threshold Th₂, the stimulus parameter determining unit 13 may determine the frequency f change amount Δf and the sound interval T change amount ΔT using the distance change amount ΔM. When the absolute value of the distance change amount ΔM is larger than the second threshold Th₂, the parameters of the stimulus are adjusted in such a manner that the larger the distance change amount ΔM, the smaller the stimulus.

Each of the first threshold Th₁ and the second threshold Th₂ may be stored in an internal memory of the stimulus parameter determining unit 13 or may be given from the outside of the behavior modification device 2.

In the behavior modification device 2 illustrated in FIG. 1, the stimulus parameter determining unit 13 determines the frequency f change amount Δf and the sound interval T change amount ΔT as the parameters of the stimulus using the distance change amount ΔM. However, this is merely an example, and the stimulus parameter determining unit 13 may change the kind of sound in a case where the absolute value of the distance change amount ΔM is larger than a third threshold Th₃. For example, in a case where a stimulus to be given to an organism is a tone burst, when the absolute value of the distance change amount ΔM is larger than the third threshold Th₃, the stimulus parameter determining unit 13 may change the stimulus of the tone burst to, for example, a sine wave stimulus, a triangular wave stimulus, a sweep sound stimulus, a time stretched pulse (TSP) signal stimulus, a white noise stimulus, a pink noise stimulus, or a brown noise stimulus.

The third threshold Th₃ may be stored in an internal memory of the stimulus parameter determining unit 13 or may be given from the outside of the behavior modification device 2.

In the behavior modification device 2 illustrated in FIG. 1, the behavior identifying unit 12 identifies the behavior of the threatening target organism on the basis of the distance change amount ΔM. However, this is merely an example, and when the sensor 1 is, for example, a laser speedometer that measures a speed of the threatening target organism, the behavior identifying unit 12 may identify the behavior of the threatening target organism on the basis of the speed measured by the sensor 1.

For example, when the speed of the threatening target organism tends to increase, the behavior identifying unit 12 determines that the behavior of the threatening target organism is “behavior of moving away from the protective area 4”. For example, when the speed of the threatening target organism tends to decrease, the behavior identifying unit 12 determines that the behavior of the threatening target organism is “behavior of approaching the protective area 4”. For example, when there is no change in the speed of the threatening target organism, the behavior identifying unit 12 determines that the behavior of the threatening target organism is “behavior of stopping without moving”.

In the behavior modification system illustrated in FIG. 1, the sensor 1 detects a threatening target organism present in the monitoring area. In a case where a protection target present in the protective area 4 is an organism, for example, when the sensor 1 includes a camera, it is possible to distinguish between a threatening target organism and the organism to be protected by analyzing an image captured by the camera. Therefore, even when the organism to be protected passes through a net around the protective area 4 and goes out to the monitoring area outside the protective area 4, an effective stimulus to the threatening target organism can be generated.

### Second Embodiment

In a second embodiment, a behavior modification device 2 including a stimulus data storing unit 15 storing stimulus data will be described.

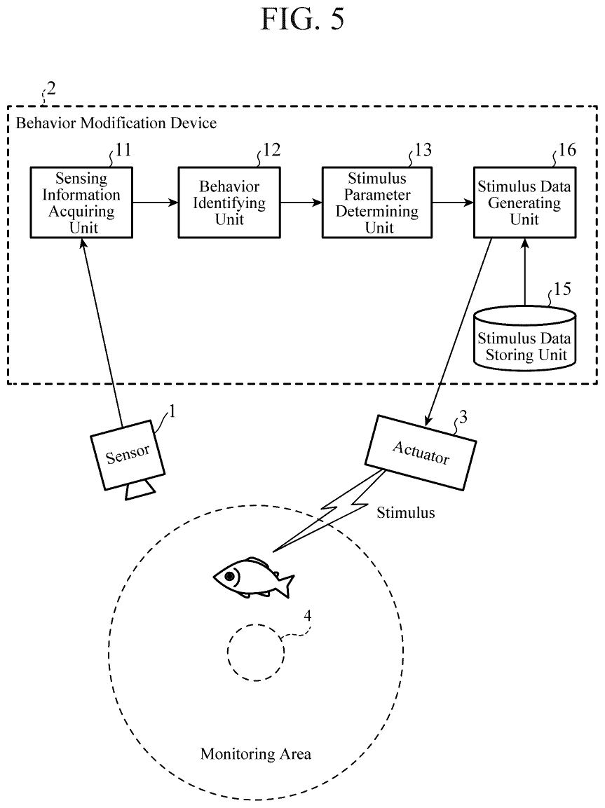

FIG. 5 is a configuration diagram illustrating a behavior modification system including the behavior modification device 2 according to the second embodiment. In FIG. 5, the same reference numerals as in FIG. 1 indicate the same or corresponding parts, and therefore description thereof is omitted.

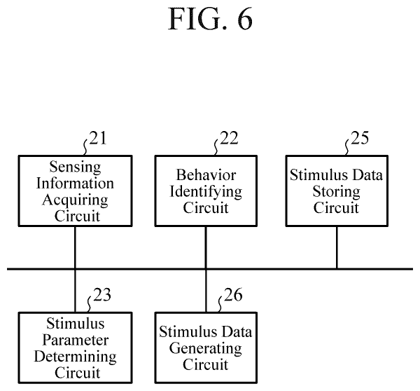

FIG. 6 is a hardware configuration diagram illustrating hardware of the behavior modification device 2 according to the second embodiment. In FIG. 6, the same reference numerals as in FIG. 2 indicate the same or corresponding parts, and therefore description thereof is omitted.

The behavior modification device 2 includes a sensing information acquiring unit 11, a behavior identifying unit 12, a stimulus parameter determining unit 13, the stimulus data storing unit 15, and a stimulus data generating unit 16.

The stimulus data storing unit 15 is implemented by, for example, a stimulus data storing circuit 25 illustrated in FIG. 6.

The stimulus data storing unit 15 stores stimulus data for generating a stimulus to be given to a threatening target organism.

The stimulus data generating unit 16 is implemented by, for example, a stimulus data generating circuit 26 illustrated in FIG. 6.

The stimulus data generating unit 16 acquires a parameter of a stimulus from the stimulus parameter determining unit 13.

The stimulus data generating unit 16 acquires stimulus data from the stimulus data storing unit 15 instead of generating stimulus data for generating a stimulus.

The stimulus data generating unit 16 adjusts the stimulus data on the basis of the parameter of the stimulus.

The stimulus data generating unit 16 outputs the stimulus data after the parameter adjustment to the actuator 3.

In FIG. 5, it is assumed that each of the sensing information acquiring unit 11, the behavior identifying unit 12, the stimulus parameter determining unit 13, the stimulus data storing unit 15, and the stimulus data generating unit 16, which are constituent elements of the behavior modification device 2, is implemented by dedicated hardware as illustrated in FIG. 6. That is, it is assumed that the behavior modification device 2 is implemented by a sensing information acquiring circuit 21, a behavior identifying circuit 22, a stimulus parameter determining circuit 23, the stimulus data storing circuit 25, and the stimulus data generating circuit 26.

To the stimulus data storing circuit 25, for example, a nonvolatile or volatile semiconductor memory such as random access memory (RAM), read only memory (ROM), flash memory, erasable programmable read only memory (EPROM), or electrically erasable programmable read only memory (EEPROM), a magnetic disk, a flexible disk, an optical disc, a compact disc, a mini disc, or a digital versatile disc (DVD) corresponds.

To each of the sensing information acquiring circuit 21, the behavior identifying circuit 22, the stimulus parameter determining circuit 23, and the stimulus data generating circuit 26, for example, a single circuit, a composite circuit, a programmed processor, a parallel programmed processor, an ASIC, a FPGA, or a combination thereof corresponds.

The constituent elements of the behavior modification device 2 are not limited to those implemented by dedicated hardware, and the behavior modification device 2 may be implemented by software, firmware, or a combination of software and firmware.

In a case where the behavior modification device 2 is implemented by software, firmware, or the like, the stimulus data storing unit 15 is constituted on the memory 31 of a computer. A program for causing the computer to execute a processing procedure performed in each of the sensing information acquiring unit 11, the behavior identifying unit 12, the stimulus parameter determining unit 13, and the stimulus data generating unit 16 is stored in the memory 31 illustrated in FIG. 3. The processor 32 illustrated in FIG. 3 executes the program stored in the memory 31.

FIG. 6 illustrates an example in which each of the constituent elements of the behavior modification device 2 is implemented by dedicated hardware, and FIG. 3 illustrates an example in which the behavior modification device 2 is implemented by software, firmware, or the like. However, this is merely an example, and some of the constituent elements of the behavior modification device 2 may be implemented by dedicated hardware, and the remaining constituent elements may be implemented by software, firmware, or the like.

Next, an operation of the behavior modification device 2 illustrated in FIG. 5 will be described. The behavior modification device 2 is similar to the behavior modification device 2 illustrated in FIG. 1 except for the stimulus data storing unit 15 and the stimulus data generating unit 16. Therefore, only operations of the stimulus data storing unit 15 and the stimulus data generating unit 16 will be described here.

In the behavior modification device 2 illustrated in FIG. 1, the stimulus data generating unit 14 generates parametric stimulus data. A stimulus preferred by a threatening target organism or a stimulus repelled by the threatening target organism may be a stimuli present in nature instead of being a parametric stimulus. Examples of the stimulus present in nature include a water flow sound, a wind sound, and a sound generated by an organism.

The stimulus data generating unit 16 acquires a parameter of a stimulus from the stimulus parameter determining unit 13, and acquires stimulus data from the stimulus data storing unit 15. The stimulus data acquired from the stimulus data storing unit 15 is not stimulus data related to a parametric stimulus, but is, for example, stimulus data related to a stimulus present in nature.

The stimulus data generating unit 16 adjusts the stimulus data on the basis of the parameter of the stimulus.

Examples of the adjustment of the stimulus data include adjustment of a frequency f of a sound by a change amount Δf and adjustment of a sound interval T by a change amount ΔT when the stimulus generated from the stimulus data is a sound.

The stimulus data generating unit 16 outputs the stimulus data after the parameter adjustment to the actuator 3.

In the above second embodiment, the behavior modification device 2 illustrated in FIG. 5 is configured to include the stimulus data storing unit 15 storing stimulus data, in which the stimulus data generating unit 16 acquires stimulus data from the stimulus data storing unit 15 instead of generating stimulus data for generating a stimulus, and adjusts the stimulus data on the basis of the parameter determined by the stimulus parameter determining unit 13. Therefore, similarly to the behavior modification device 2 illustrated in FIG. 1, it is possible to repel vermin that is an organism to be threatened without storing stimulus data corresponding to the kind of the vermin.

### Third Embodiment

In a third embodiment, a behavior modification device 2 including a behavior recording unit 17 that records a distance change amount and the like will be described.

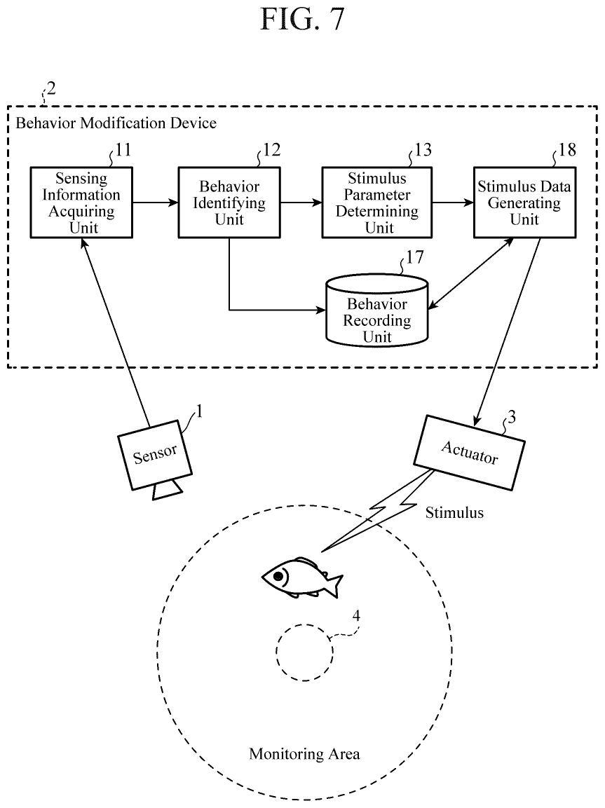

FIG. 7 is a configuration diagram illustrating a behavior modification system including the behavior modification device 2 according to the third embodiment. In FIG. 7, the same reference numerals as in FIGS. 1 and 5 indicate the same or corresponding parts, and therefore description thereof is omitted.

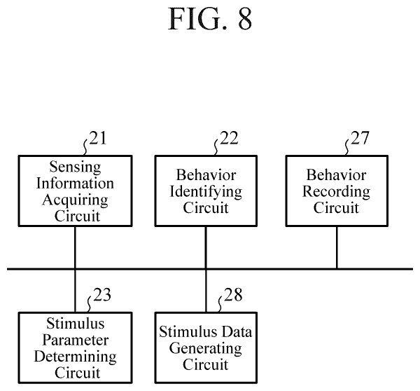

FIG. 8 is a hardware configuration diagram illustrating hardware of the behavior modification device 2 according to the third embodiment. In FIG. 8, the same reference numerals as in FIGS. 2 and 6 indicate the same or corresponding parts, and therefore description thereof is omitted.

The behavior modification device 2 includes a sensing information acquiring unit 11, a behavior identifying unit 12, a stimulus parameter determining unit 13, the behavior recording unit 17, and a stimulus data generating unit 18.

The behavior recording unit 17 is implemented by, for example, a behavior recording circuit 27 illustrated in FIG. 8.

The behavior recording unit 17 acquires first behavior information indicating behavior identified by the behavior identifying unit 12 before stimulus data is output from the stimulus data generating unit 18 to the actuator 3 and the actuator 3 generates a stimulus. In addition, the behavior recording unit 17 acquires second behavior information indicating behavior identified by the behavior identifying unit 12 after the stimulus is generated by the actuator 3.

The behavior recording unit 17 records a set of the first behavior information, the second behavior information, and the stimulus data.

The stimulus data generating unit 18 is implemented by, for example, a stimulus data generating circuit 28 illustrated in FIG. 8.

After the set of the first behavior information, the second behavior information, and the stimulus data is recorded in the behavior recording unit 17, the stimulus data generating unit 18 acquires an identification result of behavior identified by the behavior identifying unit 12, and acquires a parameter of a stimulus from the stimulus parameter determining unit 13.

The stimulus data generating unit 18 determines whether or not the behavior identified by the behavior identifying unit 12 is the same behavior as the behavior indicated by the first behavior information recorded in the behavior recording unit 17, and the behavior indicated by the second behavior information belonging to the same set as the first behavior information is behavior of moving away from a protective area 4 in the monitoring area.

When the behavior identified by the behavior identifying unit 12 is not the same behavior as the behavior indicated by the first behavior information, or when the behavior identified by the behavior identifying unit 12 is the same behavior as the behavior indicated by the first behavior information but the behavior indicated by the second behavior information is not behavior of moving away from the protective area 4 in the monitoring area, the stimulus data generating unit 18 generates stimulus data on the basis of the parameter determined by the stimulus parameter determining unit 13, similarly to the stimulus data generating unit 14 illustrated in FIG. 1.

When the behavior identified by the behavior identifying unit 12 is the same behavior as the behavior indicated by the first behavior information and the behavior indicated by the second behavior information is behavior of moving away from the protective area 4 in the monitoring area, the stimulus data generating unit 18 acquires, from the behavior recording unit 17, stimulus data belonging to the same set as the first behavior information and outputs the stimulus data to the actuator 3.

In the behavior modification device 2 illustrated in FIG. 7, the behavior recording unit 17 and the stimulus data generating unit 18 are applied to the behavior modification device 2 illustrated in FIG. 1. However, this is merely an example, and the behavior recording unit 17 and the stimulus data generating unit 18 may be applied to the behavior modification device 2 illustrated in FIG. 5.

In FIG. 7, it is assumed that each of the sensing information acquiring unit 11, the behavior identifying unit 12, the stimulus parameter determining unit 13, the behavior recording unit 17, and the stimulus data generating unit 18, which are constituent elements of the behavior modification device 2, is implemented by dedicated hardware as illustrated in FIG. 8. That is, it is assumed that the behavior modification device 2 is implemented by a sensing information acquiring circuit 21, a behavior identifying circuit 22, a stimulus parameter determining circuit 23, the behavior recording circuit 27, and the stimulus data generating circuit 28.

To the behavior recording circuit 27, for example, a nonvolatile or volatile semiconductor memory such as RAM, ROM, flash memory, EPROM, or EEPROM, a magnetic disk, a flexible disk, an optical disk, a compact disk, a mini disk, or DVD corresponds.

To each of the sensing information acquiring circuit 21, the behavior identifying circuit 22, the stimulus parameter determining circuit 23, and the stimulus data generating circuit 28, for example, a single circuit, a composite circuit, a programmed processor, a parallel programmed processor, an ASIC, a FPGA, or a combination thereof corresponds.

The constituent elements of the behavior modification device 2 are not limited to those implemented by dedicated hardware, and the behavior modification device 2 may be implemented by software, firmware, or a combination of software and firmware.

In a case where the behavior modification device 2 is implemented by software, firmware, or the like, the behavior recording unit 17 is constituted on the memory 31 of a computer. A program for causing the computer to execute a processing procedure performed in each of the sensing information acquiring unit 11, the behavior identifying unit 12, the stimulus parameter determining unit 13, and the stimulus data generating unit 18 is stored in the memory 31. The processor 32 of the computer executes the program stored in the memory 31.

FIG. 8 illustrates an example in which each of the constituent elements of the behavior modification device 2 is implemented by dedicated hardware, and FIG. 3 illustrates an example in which the behavior modification device 2 is implemented by software, firmware, or the like. However, this is merely an example, and some of the constituent elements of the behavior modification device 2 may be implemented by dedicated hardware, and the remaining constituent elements may be implemented by software, firmware, or the like.

Next, an operation of the behavior modification device 2 illustrated in FIG. 7 will be described. The behavior modification device 2 is similar to the behavior modification device 2 illustrated in FIG. 1 except for the behavior recording unit 17 and the stimulus data generating unit 18. Therefore, only operations of the behavior recording unit 17 and the stimulus data generating unit 18 will be described here.

The behavior recording unit 17 acquires stimulus data from the stimulus data generating unit 18.

In addition, the behavior recording unit 17 acquires first behavior information indicating behavior identified by the behavior identifying unit 12 before stimulus data is output from the stimulus data generating unit 18 to the actuator 3 and the actuator 3 generates a stimulus. The first behavior information includes change amount information indicating a distance change amount ΔM approaching the protective area 4 or a distance change amount ΔM moving away from the protective area 4. Here, for convenience of description, it is assumed that the behavior indicated by the first behavior information is behavior at a time tₐ. The stimulus data generated by the stimulus data generating unit 18 is generated on the basis of the behavior at the time tₐ.

In addition, the behavior recording unit 17 acquires second behavior information indicating behavior identified by the behavior identifying unit 12 after the stimulus is generated by the actuator 3. The second behavior information includes change amount information indicating a distance change amount ΔM approaching the protective area 4 or a distance change amount ΔM moving away from the protective area 4. Here, for convenience of description, it is assumed that the behavior indicated by the second behavior information is behavior at a time t_{b}. The time to is a time later than the time tₐ.

The behavior recording unit 17 records a set of the first behavior information, the second behavior information, and the stimulus data.

Note that one or more of the above sets are recorded in the behavior recording unit 17. The times tₐ of the pieces of behavior indicated by the pieces of first behavior information included in the plurality of sets are different from each other. In addition, the times t_{b} of the pieces of behavior indicated by the pieces of second behavior information included in the plurality of sets are different from each other. In addition, the times related to the pieces of stimulus data included in the plurality of sets are different from each other.

The stimulus data generating unit 18 acquires a behavior identifying result at a time to from the behavior identifying unit 12, and acquires a parameter of a stimulus from the stimulus parameter determining unit 13. The time t_{c} is a time later than the time t_{b}.

The stimulus data generating unit 18 determines whether or not the behavior at the time t_{c} is the same behavior as the behavior indicated by the first behavior information recorded in the behavior recording unit 17.

Specifically, the stimulus data generating unit 18 acquires a distance change amount ΔM calculated by the behavior identifying unit 12 as a change amount ΔM′ on the basis of the behavior at the time to.

In addition, the stimulus data generating unit 18 acquires one or more pieces of first behavior information recorded in the behavior recording unit 17.

When there is a distance change amount ΔM in which an absolute value of a difference between the distance change amount ΔM and the change amount ΔM′ is smaller than a third threshold Th₃ among the distance change amounts ΔM indicated by change amount information included in the one or more pieces of first behavior information, the stimulus data generating unit 18 determines that the behavior recording unit 17 includes first behavior information indicating the same behavior as the behavior identified by the behavior identifying unit 12.

When there are one or more distance change amounts ΔM in which an absolute value of a difference between the distance change amount ΔM and the change amount ΔM′ is smaller than the third threshold Th₃, the stimulus data generating unit 18 identifies a change amount ΔM in which the absolute value of the difference is minimum.

The stimulus data generating unit 18 acquires, from the behavior recording unit 17, second behavior information belonging to the same set as the first behavior information including the change amount information indicating the change amount ΔM in which the absolute value of the difference is minimum.

The stimulus data generating unit 18 determines whether or not the behavior indicated by the second behavior information belonging to the same set as the first behavior information is behavior of moving away from the protective area 4 in the monitoring area.

That is, when the distance change amount ΔM indicated by the change amount information included in the second behavior information is a positive value, the stimulus data generating unit 18 determines that the behavior is behavior of moving away from the protective area 4 in the monitoring area.

When the behavior at the time t_{c} is not the same behavior as the behavior indicated by the first behavior information, the stimulus data generating unit 18 generates stimulus data on the basis of the parameter determined by the stimulus parameter determining unit 13, similarly to the stimulus data generating unit 14 illustrated in FIG. 1. The stimulus data generating unit 18 outputs the generated stimulus data to the actuator 3.

In addition, when the behavior at the time to is the same behavior as the behavior indicated by the first behavior information but the behavior indicated by the second behavior information is not behavior of moving away from the protective area 4, the stimulus data generating unit 18 generates stimulus data on the basis of the parameter determined by the stimulus parameter determining unit 13, similarly to the stimulus data generating unit 14 illustrated in FIG. 1. The stimulus data generating unit 18 outputs the generated stimulus data to the actuator 3.

When the behavior at the time to is the same behavior as the behavior indicated by the first behavior information and the behavior indicated by the second behavior information is behavior of moving away from the protective area 4 in the monitoring area, the stimulus data generating unit 18 acquires, from the behavior recording unit 17, stimulus data belonging to the same set as the first behavior information. The stimulus data generating unit 18 outputs the acquired stimulus data to the actuator 3.

In the above third embodiment, the behavior modification device 2 illustrated in FIG. 7 is configured to include the behavior recording unit 17 that records a set of first behavior information indicating behavior identified by the behavior identifying unit 12 before stimulus data is output from the stimulus data generating unit 18 to the actuator 3 and a stimulus is generated by the actuator 3, second behavior information indicating behavior identified by the behavior identifying unit 12 after the stimulus is generated by the actuator 3, and the stimulus data. In addition, the behavior modification device 2 illustrated in FIG. 7 is configured in such a manner that the stimulus data generating unit 18 outputs, to the actuator 3, stimulus data belonging to the same set as the first behavior information instead of generating stimulus data on the basis of a parameter determined by the stimulus parameter determining unit 13 when the behavior identified by the behavior identifying unit 12 after a set of the first behavior information, the second behavior information, and the stimulus data is recorded in the behavior recording unit 17 is the same behavior as the behavior indicated by the first behavior information recorded in the behavior recording unit 17, and the behavior indicated by the second behavior information belonging to the same set as the first behavior information is behavior of moving away from the protective area 4 in the monitoring area. Therefore, similarly to the behavior modification device 2 illustrated in FIG. 1, the behavior modification device 2 illustrated in FIG. 7 can repel vermin that is an organism to be threatened without storing stimulus data corresponding to the kind of the vermin. In addition, the behavior modification device 2 illustrated in FIG. 7 can repel vermin more quickly than the behavior modification device 2 illustrated in FIG. 1.

Note that the present disclosure can freely combine the embodiments to each other, modify any constituent element in each of the embodiments, or omit any constituent element in each of the embodiments.

### INDUSTRIAL APPLICABILITY

The present disclosure is suitable for a behavior modification device, a behavior modification method, and a behavior modification system.

### REFERENCE SIGNS LIST

1: sensor, 2: behavior modification device, 3: actuator, 4: protective area, 11: sensing information acquiring unit, 12: behavior identifying unit, 13: stimulus parameter determining unit, 14: stimulus data generating unit, 15: stimulus data storing unit, 16: stimulus data generating unit, 17: behavior recording unit, 18: stimulus data generating unit, 21: sensing information acquiring circuit, 22: behavior identifying circuit, 23: stimulus parameter determining circuit, 24: stimulus data generating circuit, 25: stimulus data storing circuit, 26: stimulus data generating circuit, 27: behavior recording circuit, 28: stimulus data generating circuit, 31: memory, 32: processor

1. A behavior modification device comprising:
processing circuitry configured to acquire sensing information of a sensor to observe a monitoring area;
identify behavior of an organism to be threatened present in the monitoring area on a basis of the acquired sensing information;
determine a parameter of a stimulus to be given to the organism on a basis of the identified behavior; and
generate stimulus data for generating the stimulus on a basis of the determined parameter and output the stimulus data to an actuator for generating a stimulus,
wherein the stimulus is a sound wave,
the parameter of the stimulus is at least one of a frequency change amount and a sound interval change amount,
wherein when the identified behavior of the organism corresponds to behavior of approaching a protective area in the monitoring area or behavior of stopping, the processing circuitry determines the parameter of the stimulus in such a manner as to increase the at least one of the frequency change amount and the sound interval change amount, and
when the identified behavior of the organism corresponds to behavior of moving away from the protective area, the processing circuitry determines the parameter of the stimulus in such a manner as to decrease the at least one of the frequency change amount and the sound interval change amount.

2. The behavior modification device according to claim 1, wherein
in a case where the identified behavior of the organism is behavior of approaching a protective area in the monitoring area,
when an absolute value of a distance change amount approaching the protective area is equal to or less than a first threshold, the processing circuitry maintains the parameter of the stimulus, and
when the absolute value of the distance change amount approaching the protective area is larger than the first threshold, the processing circuitry adjusts the parameter of the stimulus in such a manner as to increase the at least one of the frequency change amount and the sound interval change amount, as the distance change amount approaching the protective area becomes larger, and
in a case where the identified behavior of the organism is behavior of moving away from the protective area,
when an absolute value of a distance change amount moving away from the protective area is equal to or less than a second threshold, the processing circuitry maintains the parameter of the stimulus, and
when the absolute value of the distance change amount moving away from the protective area is larger than the second threshold, the processing circuitry adjusts the parameter of the stimulus in such a manner as to decrease the at least one of the frequency change amount and the sound interval change amount, as the distance change amount moving away from the protective area becomes larger.

3. The behavior modification device according to claim 1, wherein
the processing circuitry acquires the stimulus data instead of generating the stimulus data for generating the stimulus, and adjusts the stimulus data on a basis of the determined parameter.

4. The behavior modification device according to claim 1,
first behavior information indicating the identified behavior before the stimulus data is output to the actuator and the stimulus is generated by the actuator,
second behavior information indicating the identified behavior after the stimulus is generated by the actuator, and
the stimulus data, wherein
processing circuitry
outputs, to the actuator, stimulus data belonging to the same set as the first behavior information instead of generating stimulus data on a basis of the determined parameter when the identified behavior after the set of the first behavior information, the second behavior information, and the stimulus data is recorded is the same behavior as the behavior indicated by the first behavior information recorded, and the behavior indicated by the second behavior information belonging to the same set as the first behavior information is behavior of moving away from a protective area in the monitoring area.

5. A behavior modification method comprising:
acquiring sensing information of a sensor to observe a monitoring area;
identifying behavior of an organism to be threatened present in the monitoring area on a basis of the acquired sensing information;
determining a parameter of a stimulus to be given to the organism on a basis of the identified behavior; and
generating stimulus data for generating the stimulus on a basis of the determined parameter, and outputting the stimulus data to an actuator for generating the stimulus,
wherein the stimulus is a sound wave,
the parameter of the stimulus is at least one of a frequency change amount and a sound interval change amount,
the behavior modification method further comprising:
determining the parameter of the stimulus in such a manner as to increase the at least one of the frequency change amount and the sound interval change amount when the identified behavior of the organism corresponds to behavior of approaching a protective area in the monitoring area or behavior of stopping; and
determining the parameter of the stimulus in such a manner as to decrease the at least one of the frequency change amount and the sound interval change amount when the identified behavior of the organism corresponds to behavior of moving away from the protective area.

6. A behavior modification system comprising:
a sensor to observe a monitoring area;
processing circuitry configured to
acquire sensing information of the sensor;
identify behavior of an organism to be threatened present in the monitoring area on a basis of the acquired sensing information
determine a parameter of a stimulus to be given to the organism on a basis of the identified behavior;
generate stimulus data for generating the stimulus on a basis of the determined parameter; and
an actuator to generate the stimulus to be given to the threatening target organism on a basis of the generated stimulus data
wherein the stimulus is a sound wave,
the parameter of the stimulus is at least one of a frequency change amount and a sound interval change amount,
wherein when the identified behavior of the organism corresponds to behavior of approaching a protective area in the monitoring area or behavior of stopping, the processing circuitry determines the parameter of the stimulus in such a manner as to increase the at least one of the frequency change amount and the sound interval change amount, and
when the identified behavior of the organism corresponds to behavior of moving away from the protective area, the processing circuitry determines the parameter of the stimulus in such a manner as to decrease the at least one of the frequency change amount and the sound interval change amount.
